(19) United States
(12) Patent Application Publication
(10) Pub. No.: US 2007/0150188 A1
(43) Pub. Date: Jun. 28, 2007

(54) FIRST-PERSON VIDEO-BASED TRAVEL PLANNING SYSTEM

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/683,394

(22) Filed: Mar. 7, 2007

Related U.S. Application Data
(63) Continuation-in-part of application No. 11/341,025, filed on Jan. 27, 2006.
(60) Provisional application No. 60/685,219, filed on May 27, 2005.
(60) Provisional application No. 60/797,948, filed on May 6, 2006.

(51) Int. Cl. G01C 21/32

(52) U.S. Cl. 701/211; 340/995.1

(57) ABSTRACT

A system provides a first person video depiction of a planned travel route from a designated start location to a designated destination location in response to a user's travel planning request. A user interface receives a start location and a destination location for the travel route from a user. A routing component plans the travel route based between the start location and the destination location. A first person image database stores still images associated with locations between the start location and the destination location. The still images display first-person photographic imagery in a driving direction of the travel route. A video generator generates high-speed video media depicting at least a portion of the travel route from the start location to the destination location along a planned travel path. The video media is generated by sequencing a series of the still images associated with locations between the start location and the destination location. A display monitor displays the high-speed video media to the user.

### RELATED APPLICATION DATA

This application claims priority under 35 U.S.C. 119(e) to U.S. Provisional Patent Application No. 60/797,948, filed May 6, 2006, the disclosure of which is hereby incorporated by reference herein in its entirety; this application is a continuation-in-part of U.S. patent application Ser. No. 11/341,025, entitled IMAGE-ENHANCED NAVIGATION SYSTEMS AND METHODS, filed Jan. 27, 2006, which is a nonprovisional of U.S. Patent Application No. 60/685,219, of Rosenberg, filed May 27, 2005, for IMAGE-ENHANCED NAVIGATION SYSTEMS AND METHODS; all of which are incorporated by reference in their entirety.

### FIELD OF THE APPLICATION

The present invention relates to an automated travel planning system.

### BACKGROUND

A variety of mapping and travel planning systems presently exist and are widely popular, including web-based mapping applications, travel planning applications, and in-vehicle navigation systems. With respect to mapping and travel planning applications, a variety of software tools currently exist such as Mapquest™, Yahoo Maps™, Google Maps™, Windows Live Local™, Google Earth™, and Microsoft Virtual Earth™ that provide location-to-location navigational instructions to users. Such instructions are generally provided in the form of driving directions and are commonly employed by users in advance of a driving trip. The software tools generally include intelligent route planning routines that find the most direct and/or the shortest route between a designated start location and a designated destination location. Advanced tools have been proposed that consider changing traffic conditions and road construction conditions in planning an optimal route for the user from the designated start location to the designated destination location. The software tools generally provide driving directions in the form of textual instructions including the names of roads to be taken, the distances they are to be traveled, and the turns and/or exits that are required for a driver to move from road to road upon the designated route. The software tools generally also provide a visual representation of the route depicted as a graphical map with the route path overlaid proximately to depict the path required of a driver to get from the start location to the destination location along the defined route. Such tools are highly valuable to users, providing them with both textual and visual instructions to follow when they traverse the intervening roads and paths between the designated start location and the designated stop location. Some tools such as Google Earth™ and Microsoft Virtual Earth™ also provide visual information in the form of aerial photography and/or satellite imagery that provide overhead views of the physical terrain through which the intervening roads and paths traverse. An example of a mapping software application, often referred to as a “travel planning system,” is described in U.S. Pat. No. 6,498,982, the disclosure of which is hereby incorporated by reference in its entirely. Another example mapping application is described in U.S. Pat. No. 6,871,142, the disclosure of which is also hereby incorporated by reference in its entirety.

Similar to the mapping applications described above, a variety of in-vehicle navigation systems exist that provide location to location mapping instructions to users. Unlike the mapping software described above that are generally used in advance of a trip, the in-vehicle applications are generally used during a trip to provide continuously updated driving directions to users as they follow a planned route from a designated start location to a designated destination location. The driving instructions are generally provided by the vehicle navigation system in the form of graphical, textual, and often auditory information. For example, users are generally provided with a graphical map, textual driving instructions, and/or computer generated verbal instructions, indicating which roads to take, how long to take them, and where to turn and/or exit to follow the prescribed route from the designated start location to the designated destination location. Because the vehicle navigation system is generally provided with real-time GPS data as to the vehicle's current location, the designated start-location usually need not be entered by the user and is assumed to be the current physical location the vehicle at the time the mapping request is made. Vehicle navigation systems generally include intelligent route planning routines that find the most direct and/or the shortest distance route between the designated start location and a designated destination location. Advanced tools have been proposed that consider changing traffic conditions and/or road construction in planning an optimal route for the user from the designated start location to the designated destination location. As with the mapping software systems described above, vehicle navigation systems generally provide a visual representation of the route depicted as a graphical map with the route path overlaid proximately to depict the path required of a driver to get from the start location to the destination location along the defined route. Such tools are highly valuable to users, providing them with textual, visual, and audio instructions to follow as they traverse the intervening roads and paths between the designated start location and the designated stop location. Example vehicle navigation systems are described in U.S. Pat. Nos. 5,359,527 and 5,442,557, the disclosures of which are hereby incorporated by reference in their entirety.

While the mapping software applications and vehicle navigation systems described above are highly valuable tools, they do not provide users with a complete visual representation of the route they will take from the designated start location to the designated destination location. More specifically, while the current systems are configured to provide imagery such as graphical maps, routing lines, and overhead aerial photos and/or satellite photos, they do not provide users with a first-person view of what they should expect to see as they travel in their vehicle from the designated start location to the designated destination location. Such a first person view would be highly useful for a user, helping the user to visualize the required routes and/or turns, and preparing user's to identify visual landmarks they will to see along the way. Such a first person view would also be helpful in allowing a user to select a scenic route from among a plurality of possible routes that he or she might take.

### SUMMARY

Embodiments of the present invention comprise an automated travel planning system that provides users with a high-speed video depicting a first-person view of a planned travel route from a designated start location to a designated destination location. The system employs a database of stored digital images, each of the digital images depicting the first-person perspective that would be seen by a user traveling at a particular location upon a particular road in a particular direction of travel. Each of the images is generally a still digital photograph that is stored in a standard format and is relationally associated with locative data indicating on which road the image was taken, where upon the road the image was taken, and which travel direction upon the road the image represents. The data associated with each image may include, for example, Global Positioning System (“GPS”) data, street identification data, and travel direction data. In addition, other data may be stored in relational association with each still image, including, for example, lighting condition data, weather condition data, and seasonal information data, for the time and place the image was captured. Some embodiments of the invention further include a user interface through which a user may indicate a desired start location and/or destination location. The system then produces a high-speed video depicting the travel route from the start location to the destination location along a planned travel path, the high-speed video produced by sequencing an appropriate series of stored still images, with each of the stored still images in the series being associated with sequential intermediate locations between the start-location and the destination-location along the intervening roads of travel. In this way a video is constructed that depicts the travel route, in a first person perspective, from the start location to the destination location, where the speed of the video is controlled based upon the physical spacing between the intermediate locations at which each of still images in the series were taken and based upon the frame rate at which the video is played. In general, the video is played at a frame-rate such that the full travel route can be viewed over a short duration such as, for example, 15 to 90 seconds. In this way a user can quickly view the planned travel route in advance of travel, with the video presenting the route similar to as it will be seen by a driver when the route is actually traversed.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates an automated travel planning system according to the prior art;

FIG. 2 illustrates a displayed overhead map image with a highlighted route of travel displayed upon it according to the prior art;

FIG. 3 illustrates an enhanced automated travel planning system according to at least one embodiment of the invention;

FIG. 4 illustrates a display window that represents how a travel route may be displayed to a user upon a Display Monitor according to at least one embodiment of the invention;

FIG. 5 illustrates an example User Interface according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the invention are directed to an automated travel planning system that provides users with a high-speed video depicting a first-person view of a planned travel route from a designated start location to a designated destination location. The system employs a database of stored digital images, each of the digital images depicting the first-person perspective that would be seen by a user traveling at a particular location upon a particular road in a particular direction of travel. Each of the images is relationally associated with locative data indicating where the image was taken as well as the travel direction. The data associated with each image may include, for example, GPS data, street identification data, travel direction data, lighting condition data, and seasonal information data, for the time and place the image was captured. A user interface is provided through which a user may indicate a desired start location and/or destination location. The system then produces a high-speed video depicting the travel route from the start location to the destination location along a planned travel path, the high-speed video produced by sequencing a series of stored still images associated with locations between the start-location and the destination-location along the intervening roads of travel. The video is played at a frame-rate such that the travel route can be viewed over a short duration, for example 15 to 90 seconds. In this way a user can quickly view the planned travel route in advance of travel similar to how it will be seen when traversed.

Embodiments of the present invention relate generally to navigation systems and/or travel planning systems that provide location-to-location navigational instructions to users. Some embodiments of the present invention relate to automobile navigation systems that provide location-to-location travel instructions to drivers as they drive their automobile. Some embodiments of the present invention relate to navigational support software such as Mapquest™, Yahoo Maps™, Google Maps™, Windows Live Local™, Google Earth™, and Microsoft Virtual Earth™ that provide location-to-location mapping instructions to users as they plan a vehicle trip. Such software is often called an “automated travel planning system.”

Embodiments of the present invention providing systems, methods, and computer program products that enable a user to view a high-speed video that depicts the actual travel path, as real world imagery in a first-person perspective, that the user should expect to see as he or she travels from a designated start location to a designated destination location along a particular planned travel route or a portion thereof. By “first-person perspective” it is meant that the user will view the travel path from a perspective substantially similar to that which would be seen when driving a real vehicle along the real travel route, or a portion thereof, from a designated start location to a designated destination location.

Embodiments of the present invention comprise an automated travel planning system that provides users with navigational travel information in the form of a high-speed video depicting the physical route from a designated start location to a designated destination location, with the high-speed video being presented in the first-person perspective of the traveler. More specifically, the embodiments enable a user to view a high-speed video rendition of what it would look like for the user to travel in an automobile from the designated start location to the designated destination location along a planned route of travel. The embodiments generate the high-speed video using a database of real-world image data, with the real-world image data comprising digital still images depicting drivers-eye views captured upon real roads of travel. The high-speed video is produced by sequencing a series of digital images captured between the start-location and the destination-location along the intervening roads or paths of travel. The video is played at a frame-rate such that the travel route can be viewed over a short time duration such as, for example, 15 to 90 seconds. In this way a user can quickly view the planned travel route in advance of travel as it will be seen when traversed by the user.

Embodiments of the present invention employ a database of captured digital still images, with each of the captured digital images depicting the first-person perspective that would be seen by a user traveling in a vehicle at a particular location upon a particular road of travel. Methods and apparatus for generating, maintaining, accessing, and using such a database of first-person vehicular travel imagery is disclosed in co-pending U.S. patent applications by the present inventor, including U.S. provisional application Ser. No. 60/685,219, filed May 27, 2005, and U.S. application Ser. No. 11/341,025, filed Jan. 27, 2006, the disclosures of which are both incorporated herein by reference. As disclosed in the co-pending applications, the digital images in the database are captured by one or more cameras mounted upon a vehicle, and the cameras are configured to capture images from a perspective that is similar to that which a driver would see when driving a typical vehicle upon the given road of travel. Each of the digital images is stored in the database in relational association with locative information indicating upon which road the image was captured, where upon the road the image was taken as well as which direction of travel upon the road the image represents. The data associated with each image may include, for example, GPS data, street identification data, and travel direction data. In addition, other data may be stored in relational association with each still image, including, for example, lighting condition data, weather condition data, time/date data, and seasonal information data, for the time and place the image was captured.

In a preferred embodiment of the present invention the still digital images that are captured are stored in the database at regular spatial intervals along a given road of travel, for example every 1 to 100 yards. In some embodiments the spatial interval employed for a particular road of travel is dependent upon the speed limit for that road and/or the number of potential destinations, turns, and/or exits on the particular road. For example, the main street of a town that has many turns and/or destinations and has a slow speed limit may be configured in the database such that still images are captured and stored for relatively frequent spatial intervals, such as every 3 yards, along the road of travel. Alternatively, a freeway that has a much lower spatial frequency of turns, exits, and/or destinations, and has a much faster speed limit, may be configured in the database such that still images are captured and stored for relatively larger spatial intervals such as every 50 yards, along the road of travel.

The co-pending patent applications (60/685,219 and 11/341,025) also disclose that real-world driver-eye image data may be methodically captured and stored through automatic processes by a computer-controlled digital camera mounted upon a vehicle. The automatic process is generally configured such that the digital camera captures driver's-eye perspective images of the real-world as the vehicle traverses real-world roads, thereby building a comprehensive database that includes digital still images captured at frequent intervals upon regularly traveled roadways. Such digital still images may be captured for example, at regular distance intervals along the real-world roads. The distance interval may be fixed or may be set for a particular road, either manually or based upon data associated with the particular road. In some embodiments the distance interval is set based upon the speed-limit associated with the particular road, a larger distance intervals being used for higher speed-limit roads. This is because people generally desire less informational detail upon higher speed-limit roads than they desire on slower speed-limit roads. Each still digital image stored in the database may be a traditional digital photograph, a stereoscopic digital image pair, a 3D digital image, or other digital imaging convention. In some embodiments the digital image may be an omni-directional image format in which case it is will be stored with relational association to a reference orientation that orients the image to the real physical world.

The first-person digital still images that are captured and stored in the image database are relationally associated within the database with the current road of travel on which it was captured, the specific location upon the road of travel at which it was captured, and the direction of travel that the image represents. For example, each captured image that is stored in the database may be relationally associated with the travel direction for which the image represents. In this way both northbound and southbound images may be stored for a particular location upon a particular road in the database. The images may also be relationally associated with the ambient lighting conditions at which the image was taken—for example, both daylight and nighttime images may be stored for a particular location upon a particular road in the database. The images may also be relationally associated with the seasonal conditions for which the image was taken—for example winter, spring, summer, and fall images may each be stored for a particular location upon a particular road in the database. The images may also be relationally associated with the ambient weather conditions at which the image was taken—for example sunny, cloudy, rainy, and snowy images may each be stored for a particular location upon a particular road in the database. In this way the database disclosed in the co-pending patent applications may comprise a comprehensive set of digital still images for a plurality of locations upon a plurality of roads in a plurality of possible travel directions. The database may further comprise images for a plurality of differing lighting conditions, seasonal conditions, and/or weather conditions. As is discussed below, such a database may be used to selectively generate a high-speed video depicting what a driver will see when driving from a particular start location to a particular destination location, in a particular direction of travel along a particular route of travel. In addition the high-speed video may be selectively generated using certain images from the database such that the route of travel is depicted under particular lighting conditions, particular weather conditions, and/or particular seasonal conditions. For example, if it is currently Winter when a user makes a travel planning request to the system of the present invention, the system may selectively use images from the database that were captured during winter seasonal conditions when generating the video from the designated starting location to the designated destination location. In this way the user may not only view the route that he or she will take from a first person perspective, the user may view it as it generally appears during winter months.

Thus, embodiments of the present invention employ the aforementioned database of first-person drivers-eye perspective digital images in combination with travel planning software system, to generate a high-speed video depicting the physical route from a designated start location to a designated destination location, with the high-speed video being presented in the first-person perspective of the traveler. Embodiments of the present invention provide such functionality by (i) planning a route of travel between the designated start location and the designated destination location, (ii) accessing a set of digital images from the database, the set of digital images comprising images taken at sequential locations along the planned route of travel from the start location to the destination location, and the digital images depicting in the direction of travel required of the planned route, (iii) stringing together the digital images into a continuous video, and (iv) playing the continuous video to a user at a frame-rate that provides the user with a high-speed first-person video presentation of the travel route from the designated start location to the designated destination location, or a portion thereof. In this way a user may specify a designated start location and a designated destination location and view a high speed video depicting what it would look like for the user to travel in an automobile from the designated start location to the designated destination location along a planned route of travel in the planned direction of travel.

In some embodiments the above process further includes (a) specifying and/or identifying ambient conditions such as lighting conditions, weather conditions, and/or seasonal conditions, for the planned travel by the user and (b) constructing the video by selecting images from the database that substantially match the expected lighting conditions, weather conditions, and/or seasonal conditions that the user will likely travel under. Such ambient conditions may be entered by the user or may be inferred by the software based upon the time and/or date at which the travel planning request was made. Current and/or expected weather conditions may be determined by the system by accessing an Internet-based weather service for locations along the planned route of travel. In this way a user may enter the date and time that he or she plans to make a particular trip from a designated start location to a designated destination location and the system may select images with lighting conditions and/or weather conditions and/or seasonal conditions that substantially match the ambient conditions the user is likely to encounter when making the actual trip at the indicated time and date.

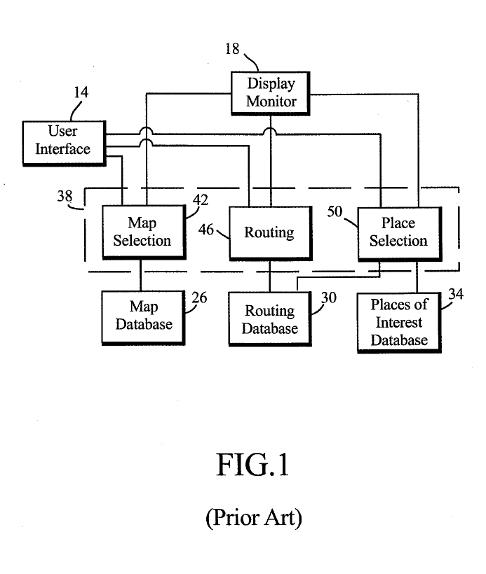

The portion of the process discussed above that involves receiving a designated start location and a designated destination location and automatically planning a route of travel between them (i.e., step i above) is generally handled by the vehicle navigation system and/or mapping software application portion of embodiments of the present invention. Many such vehicle navigation systems and/or mapping software applications currently exist that perform such functions and are referred to herein summarily as automated travel planning systems. FIG. 1 illustrates an automated travel planning system according to the prior art. While there are various ways to configure such a system, FIG. 1 illustrates a block diagram of an automated travel planning system that employs three separate databases, including a geographic map database 26 for storing geographic map data and overhead map images for numerous geographic regions, a routing database 30 for storing node and link data for roads geographically located within the geographic regions and for storing place data indicating the geographic location of places such as towns and cities, and a places of interest database 34 containing the geographic locations of numerous places of interest. A processor 38 within the automated travel planning system may be divided into several functional components, including a map selection component 42, a routing component 46, and a place selection component 50. Example details of each functional component are disclosed in U.S. Pat. No. 6,498,982, the disclosure of which is incorporated by reference in its entirety.

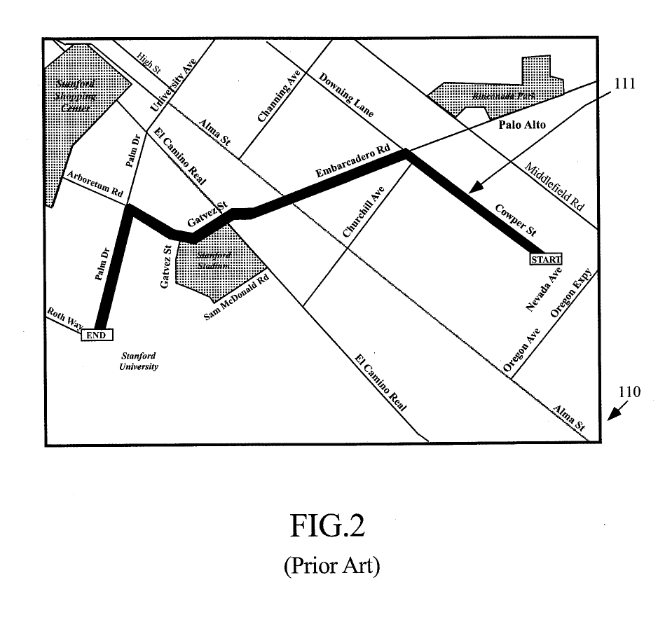

In response to user input at the user interface 14, the map selection component 42 chooses a map image from the map database 26 for display on the display monitor 18. After a user selects, via the user interface 14, a start location (i.e., a departure point) and a destination location (i.e., an arrival point), the routing component 46 employs the routing database 40 to generate a route between the selected start location and destination location. The generated route is displayed on the display monitor 18. This may be performed in a number of ways, for example a graphical highlight of the intervening roads between the start location and the destination location along the planned route of travel. FIG. 2 illustrates a displayed overhead map image with a highlighted route of travel displayed upon it according to the prior art. In this example, a user had previously selected a start location upon California Avenue in Palo Alto, Calif. and a destination location upon Stanford University campus in Palo Alto, Calif. The routing routines 46 then plan a route of travel between the start location and the destination location. The planned route of travel is then displayed as a graphical highlight 111 upon the graphical overhead map image 110 as shown in FIG. 2. This provides the user with an annotated graphical map of the region, enabling the user to easily follow travel directions from the start location to the destination location.

However, the user of this prior art system is provided only with an abstract overhead visual representation of the route of travel, not with a first-person view of the real-world route of travel as will be seen when he or she actually traverses the route. Thus, the user is not provided with a real-world visual representation of what the actual roads he or she will travel will look like from the ground while driving, nor is the user provided with a real-world visual representation of what critical landmarks will look like from the ground while driving. In other words, the user does not really know what to visually expect or look for while driving—he or she just has an abstract graphical rendition presented from above. Thus, there is a substantial need for additional methods, apparatus, and computer program products, as is disclosed herein, such that a user of an automated travel planning system may be provided with a first person video presentation of the real-world route of travel from a designated start location to a designated destination location, or a selected portion thereof. In particular there is a substantial need for methods, apparatus, and computer program products, as disclosed herein, such that a user of an automated travel planning system may be provided with a high-speed video presentation of the real-world route of travel from a designated start location to a designated destination location from a perspective that is substantially similar to that which the user will see when actually traveling the route. In some embodiments of the present invention, the presented video may be generated with lighting conditions, seasonal conditions, and/or weather conditions that the user will likely view when actually traveling the route.

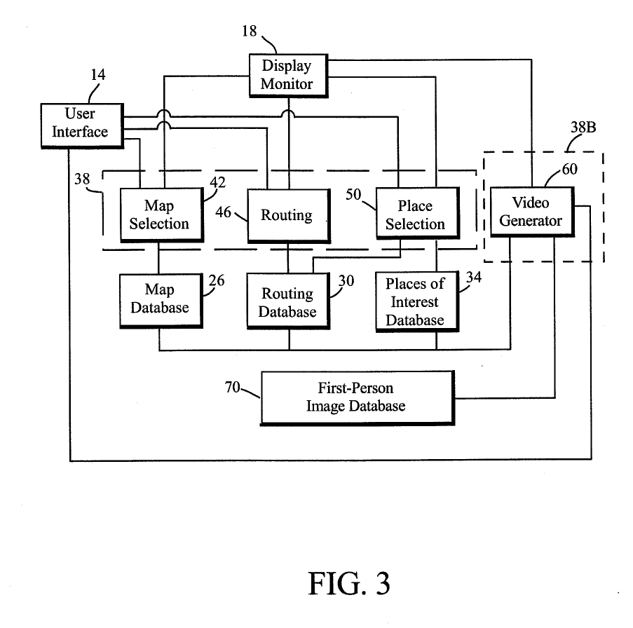

FIG. 3 illustrates an enhanced automated travel planning system according to at least one embodiment of the invention. The enhanced travel planning system is configured to enable the generation and presentation of first-person high-speed video renditions of real-world travel routes from designated start locations to designated destination locations along an automatically planned intervening route of travel. As shown, the system includes a First-Person Image Database 70 that is accessible by and/or in communication with a Video Generator module 60. The Video Generator module 60 may also be in communication with a Map Database 26, a Routing Database 30, and a Places of Interest Database 34. In some embodiments the functionality of some or all of databases 26, 30, 34, and 70 are combined into single database modules. The Video Generator module 60 is also in communication with a Display Monitor 18 and a User Interface 14. The Video Generator module 60 is generally implemented as a software component that runs upon one or more microprocessors 38B. The example system of FIG. 3 also includes other functional components including a Map Selection module 42, a Routing module 46, and a Place Selection module 50. In this particular embodiment these modules (42, 46, and 50), are implemented as software components running upon one or more microprocessors 38. In some embodiments microprocessor 38 and microprocessor 38B may in fact be the same piece of hardware that shares resources by multitasking among software components. In some embodiments the functional modules and databases are locally resident on the same computer system. In other embodiments the functional modules access one or more of the databases over a communication network such as the Internet.

The example system of FIG. 3 is operative to receive a designated start location and a designated destination location from a user and/or a component of the user. In some embodiments the user enters the start and destination location manually by typing or selecting location information using user interface 14. In some embodiments the start location is accessed from a GPS sensor or other locative sensor local to the user. This is because the start location is often defined as the current geospatial location of the user within the real physical world as determined by a GPS sensor or other locative sensor or component. In some embodiments the user may select one or both of the designated start location and/or designated destination location by graphically selecting a point upon a displayed map. This is generally achieved by Map Selection module 42 displaying a graphical overhead map image based upon data received from Map Database 26. The user may also specify planned intervening stops on the route, for example rest stops, meal stops, and/or sight seeing stops. The user may further enter expected time durations to be spent at the stops. The user may enter an estimated start-time and/or start-date for the particular route of travel through user interface 14. The entering of intermediate stop locations, intermediate stop durations, and/or the estimated start-time and/or start-date for the particular route of travel is a unique feature that may be used by the Video Generator module to create a first-person video that matches expected ambient conditions for the travel route. For example, time-of-day data and/or date data may be correlated with location data for the route to determine the expected lighting conditions (for example daylight or nighttime lighting), the expected seasonal conditions (for example winter, spring, summer, or fall), the expected weather conditions (for example sunny, rainy, snowy, or cloudy), for some or all portions of the expected route when traversed beginning upon the estimated time and/or date of travel. Furthermore, the Video Generator module may take into account expected time durations for portions of the route of travel based upon speed limits, expected travel conditions, and entered estimated stop locations and stop durations, to further estimate the ambient conditions to be expected at the time and date the user reaches those portions of the route of travel. In this way, some embodiments of the present invention provide a highly customized first-person video that not only shows the physical route of travel from start-location to destination location from a first person perspective, but selects the images used in the video based upon one or more expected ambient conditions for that location on the route of travel based upon the estimated time of day and/or date of year that the user will traverse the location. Additional details on this Video Generation process are described below.

Thus the process begins with a designated start location and designated destination location being received by the routines of embodiments of the present invention. In addition, intermediate stop locations and durations may be received. An estimated start-time and/or start-date may also be received. Some or all of this data is used by Routing module 46, with the access of Routing Database 30, to plan a route of travel for the user from the start location to the destination location upon intervening routes of travel. If one or more intermediate locations are entered, the Places of Interest Database 34 may further be used to identify sightseeing locations and/or rest stop locations and/or other locations that a user may likely choose to stop at. The Routing module 30 then plans the desired route. In some embodiments a plurality of routes may be generated for the user to select among.

Once one or more travel routes have been generated by Routing module 46, the embodiments of the present invention provide the user with the option of viewing a first-person high-speed video rendition of the route from the start location to the destination location, or a portion thereof. The process may be automatically performed or may be performed in response to a user input such as, for example, the user selecting a particular choice or selection upon User Interface 14. The process proceeds with Video Generator module 60 creating a video by accessing First-Person Image Database 70 using routing data from Routing module 46. The routing data may take various forms but generally includes a series of node points, each node point indicating a road of travel, a location upon the road of travel, a direction upon the road of travel, and any turns or transitions to other roads of travel. The nodes are generally sequenced and/or indexed to indicate the order in which a user is expected to traverse from node to node. The node points in the routing data may further include time and date information indicating the expected time and/or date that the user will reach various intermediate points upon the planned roads of travel. The node points in the routing data may further include expected ambient conditions that the user will likely encounter when he or she reaches various intermediate points upon the planned roads of travel—the ambient conditions including, for example, the lighting conditions (i.e., daylight or nighttime lighting), the weather conditions (i.e., sunny, rainy, snowy, or cloudy), and/or the seasonal conditions (i.e., winter, spring, summer, or fall). The ambient conditions are generated by the Routing module 46 based upon an expected time and/or date of departure on the planned route of travel. The ambient conditions are also generated by the Routing module 46 based upon estimated times of travel between node points upon the planned route. The estimated times of travel are generated based upon speed limits (as may be stored within the Map Database and/or Routing Database) and/or estimated traffic conditions for particular times and dates (as may be stored within the Map Database and/or the Routing Database). The ambient conditions may further be generated by accessing external weather service databases and/or traffic service databases that indicate current and/or predicted weather conditions and/or traffic conditions for particular geospatial locations. Thus, embodiments of the present invention are configured to produce routing data for a particular planned travel route, usually in the form of node points, with the routing data indicating, for example, the planned roads of travel, a plurality of planned road locations upon the planned roads of travel, the planned direction of travel upon the planned roads of travel, the predicted travel times and dates that various locations are reached and/or traversed upon the planned roads of travel, and/or the ambient conditions that are predicted to be present when the user reaches some or all of the various location upon the planned roads of travel. Such data is referred to herein collectively as the “routing data” for a particular planned route from a designated start location to a designated destination location.

The routing data is used by the Video Generator module 60 to access the First Person Image Database 70 and retrieve a series of first-person digital photograph images (as described previously) that are stored within the First Person Image Database 70 and relationally associated with the route indicated by the routing data. For example, each retrieved image within the series of first-person digital images is accessed from the First Person Image Database 70 such that it corresponds with sequential locations within the planned route of travel upon each of the planned roads of travel, starting from the designated start location and ending with the designated destination location, each of the images being selected to correspond with the appropriate direction of travel planned within the route of travel upon each road of travel. If ambient conditions are used, each of the retrieved images is also selected from the database such that it substantially corresponds with the expected ambient conditions to be encountered when the user reaches the particular location upon the route that the respective image represents. The retrieved series of first-person digital images, once accessed, are sequenced together into a video format, each of the images being used as one or more frames of the resulting video format file. In some embodiments morphing and/or other frame averaging techniques are used to transition from one image to the next within the resulting video format file. In some embodiments a single digital image is used as multiple frames within the resulting video format file. In the simplest case, each digital image within the series of first-person digital images is used as a single frame within the resulting video format file. The resulting video format file may take many forms but is generally a standard video format file such as AVI or MPEG. The resulting video files may use data compression techniques known to the art.

In this way a series of first-person digital images are accessed from the First-Person Image Database 70 and are assembled into a video file format, the images being assembled in an sequential order that corresponds with the routing data, beginning with the designated start location and ending with the designated destination location and including a plurality of intermediate locations in their sequential order of travel along the planned travel route. Based upon the number of images used as frames in the video and the designated frame-rate of the playback of the video, the resulting video is generally configured such that it depicts a high-speed rendition of the travel route. For example if the travel route was a 200 mile trip upon Highway 101 in California from San Jose down to San Luis Obispo, the present invention may be such that images are accessed from the First-Person Image Database at an spacing such that 12 images are accessed for each mile of travel as they are relationally associated with such locations upon highway 101. In other words, each mile of travel upon highway 101 may have 12 images sequentially stored and relationally associated with 12 sequential locations along that mile of travel. Using the routing data, such images are accessed from the database at the appropriate sequential locations along Highway 101 from San Jose to San Luis Obispo. Because the trip is 200 miles and 12 images are accessed for each mile, the resulting video is constructed from 2400 images. A typical video file may be played back to the user at a frame rate of 24 frames per second. In this way the resulting video file is 100 seconds long. Thus, the user who views the resulting video file at the designated frame rate of 24 frames per second will view the entire route of travel, from the designated start location (in San Jose, Calif.) to the designated destination location (in San Luis Obispo, Calif.) that might normally take about three hours to drive in a first-person high-speed video format that plays to the user in just over a minute and a half. This is highly convenient to the user for he or she may quickly (in less than two minutes) visually review the entire travel path that he or she is expecting to take. Furthermore, the 2400 images that were used to compose the video may be selected from the First-Person Image Database such that they include ambient conditions (i.e., lighting, weather, and/or seasonal conditions) that are a good match for what the user is likely to expect to see when traveling the route. Thus if the user is going to travel at night, he or she will view a high-speed video of night driving while if the user is going to travel during the day, he or she will view a high-speed video of day driving. And if sunset is expected to occur during three hour driving period indicated by the user as he goes from San Jose to San Luis Obispo, the video may be assembled such that it transitions part way through from a depiction of day driving to a depiction of night driving based upon the routing data. Similarly weather conditions and/or seasonal conditions may be depicted within the selected images that form the resulting first-person high-speed video.

In the example above, the high-speed video is constructed to depict a 200 mile highway drive from San Jose to San Luis Obispo by sequencing 2400 images into a high speed video, with the 2400 images being accessed from the First-Person Image Database such that they are relationally associated to sequential locations upon the route of travel as indicated by the routing data. These 2400 images are accessed based upon their relational association to sequential locations upon the roadways of travel and in the direction of travel as defined by the routing data. In this particular example, these 2400 images may be accessed based upon their relational association with the roadway “Highway 101” and their relational association with the travel direction “Southbound” and their relational association with specific GPS locations that fall on the roadway along the defined route from San Jose to San Luis Obispo. Thus the Video Generator may access the images in sequential order by starting with a GPS location that is substantially upon highway 101 in San Jose and sequencing through GPS locations along Highway 101 as it heads south to San Luis Obispo. The GPS locations may be selected by the Video Generator with approximate physical spacing intervals such that the desired 12 images per mile are accessed, approximately evenly spaced. In such an example the spacing of the images, as relationally associated with the travel route, is set to approximately 1/12 of a mile. This variable is referred to herein as the Image Spacing Interval and it represents the approximate distance between images used in the generation of a video as they are each relationally associated with a location along a roadway. Thus two images that have an Image Spacing Interval of 1/12 of a mile will be relationally associated with locations upon the roadway that are approximately 1/12 mile apart. The GPS locations may be accessed at alternate Image Spacing Intervals if the system is configured to use more frequent or less frequent images per mile during highway travel. For example, the system could be configured to access 30 images per mile (i.e., an Image Spacing Interval of 1/30 mile) when constructing a high speed video. In addition the images need not be accessed at even spacing, although for general highway driving over extended distances, approximately evenly spaced images are desirable in the construction of a high-speed video. In addition GPS data need not be the locative index for the images along the particular road of travel. For example, images may be indexed based upon a distance measure (for example feet, meters, or miles) from a reference point along the roadway of travel. In one such example the images are indexed based upon the number of feet from a designated end of the roadway. The minimum Image Spacing Interval that can be used by the Video Generator module when constructing a video is based upon the data stored within the First Person Image Database—images cannot be accessed at any closer spacing than the closest spacing that exists within the stored database of images.

Thus, in the example above, a high-speed video is constructed to depict a 200 mile highway drive from San Jose to San Luis Obispo by sequencing 2400 images into a high speed video, the 2400 still images accessed from the First-Person Image Database based upon their relational association to sequential locations upon the planned route of travel as indicated by the routing data. These 2400 images are thus accessed based upon their relational association with the roadway, the travel direction, and their locative index along the roadway of travel. These 2400 images may also be accessed based upon their relational association with any ambient conditions indicated within the routing data for the current travel plan. In the example above the 2400 images are accessed such that they are approximately evenly spaced along the road of travel based upon a defined Image Spacing Interval. If only a single Image Spacing Interval value is used for the generation of the video, it will depict the travel route such that all portions of the roadway move by at approximately the same speed. There are however, many situations wherein a user may like to view certain portions of the travel route at slower speeds than other portion. For example, as the travel route approaches a place where action is to be taken (e.g., an exit is to be taken, a turn is to be made, a stop is to be made, a landmark is to be passed or identified), it is often of substantial value to display that portion of the video at a slower rate than portions of the video that depict uneventful highway driving. To accommodate this need, embodiments of the present invention are often configured to generate a video such that the speed at which the roadway passes by is slower as the video approaches a place in the planned travel route where action is to be taken or a landmark is to be identified as compared to when the video is presenting places in the planned travel route where uneventful driving is to occur. This may be achieved in a variety of ways. In one embodiment this is achieved by varying the Image Spacing Interval such that it is assigned a larger value on portions of a roadway of travel wherein no action is required of the driver and/or no landmarks of significance are being passed, and is assigned a smaller value on portions of the roadway of travel where an action is soon required (e.g., an exit or turn or stop is approaching) or where a landmark of significance is approaching. In this way a user may view a video such that portions of the travel route that are important for the user to view in detail are shown at a slower rate and with more detailed imagery (i.e., more images per mile) than other portions of the travel route that are not as important for the user to view.

As an example of how the Video Generation module 60 may be configured to vary the Image Spacing Interval when generating a video, the example above wherein a high-speed video is constructed to depict a 200 mile highway drive from San Jose to San Luis Obispo by sequencing images from the First-Person Image Database is considered based upon their relational association to sequential locations upon the planned route of travel. In some embodiments, the Video Generation module 60 may be configured to generate video for portions of the travel route that depict uneventful driving (e.g., portions wherein no turns, stops, or exits are soon to be required of the driver and/or no significant landmarks are soon to be passed) using a first Image Spacing Interval (e.g., 1/12 mile) and may be configured to generate video for other portions of the travel route that depict eventful driving (e.g., portions where turns, stops, and/or exits are soon required of the driver and/or significant landmarks are approaching) using a first Image Spacing Interval (e.g., 1/48 mile). In such an example configuration, uneventful portions of the route will be depicted in the video at four times the speed than eventful portions of the travel route. This makes efficient use of the user's time when viewing the video, allowing the user to spend more time viewing portions of the route that he or she is likely to want to attend to about and less time viewing portions of the route that he is less likely to want to attend to.

While the above example uses a first and second Image Spacing Interval for uneventful and eventful portions of the route respectively, other embodiments may use other mappings between Image Spacing Interval and visual significance of a portion of the driving route depicted in a generated video. For example, some embodiments may use a large Image Spacing Interval for uneventful driving, a smaller Image Spacing Interval when approaching a landmark, and an even smaller Image Spacing Interval when approaching a turn or exit. In some embodiments the Image Spacing Interval may be gradually shortened as a turn, exit, stop, or destination is approached in the planned travel route. In other embodiments the Image Spacing Interval may be shorted based upon the particular road of travel, a large Image Spacing Interval being used for highway driving and a shorter Image Spacing Interval used for city driving and/or side-street driving. In some embodiments the Image Spacing Interval may be set based in whole or in part upon the defined Speed Limit for a particular road of travel—the higher the speed limit the larger the Image Spacing Interval. In additional embodiments a combination of Speed Limit and uneventful/eventful designations are used to vary the Image Spacing Interval throughout the video generation process for a given video. The Image Spacing Interval may be based in whole or in part upon user input to User Interface 14. This is because some users may wish to spend more time watching a video of their planned travel route and therefore do not mind having a smaller Image Spacing Interval. For example, a user who is driving from San Jose to San Luis Obispo may not mind spending 5 full minutes watching a generated video and thus may select an Image Spacing Interval of 1/36 mile. With such a spacing, 7200 images are accessed from the database. If played back at 24 frames per second, the video will play over 300 seconds (i.e., 5 minutes).

In addition to varying the Image Spacing Interval to change the speed at which a video is played to a user, embodiments of the present invention may also vary the frame rate of playback. For example, a 7200 frame video played at 24 frames per second will play for 5 minutes as described above. The same 7200 frame video played back at 12 frames per second will play for 10 minutes. Thus, at 12 frames per second the video roadway images will appear to pass by at half the speed than if played at 24 frames per second. There is a limit to how slow it can be played, however; if played much slower than 12 frames per second, the video will appear choppy to a user rather than a continuous video. Embodiments of the present invention may also vary to the frame rate of playback to achieve speed variations in how the route is presented similar to the effect of varying the Image Spacing Interval described above. In some preferred embodiments of the present invention the user is given a control upon User Interface 14 wherein he or she can speed up or slow down the displayed travel route video by adjusting the playback frame rate. Thus, if a user wants to view a portion of the route of travel more carefully, he or she may selectively slow the frame rate of playback. In some preferred embodiments this is achieved by adjusting a knob or slider of User Interface 14. Still, even if the system supports user adjusted playback speed, the automated variation of travel route video depiction speed is highly desirable. This is because it is difficult for a user to manually adjust the speed at the correct times. An automated process that slows the video based upon the approaching location of exits, turns, stops, destinations, or landmarks is extremely valuable to users as described above. Similarly, an automated process that adjusts the video speed based upon the changing speed limits of roads within the route of travel is also extremely valuable to users as described above.

The user may manually select one or more ambient conditions using User Interface 14 and thus define what ambient conditions are to be used by Video Generator module 60 when creating a first-person high-speed video of a planned travel route. For example, the user may manually select the lighting conditions such that he or she may selectively cause the Video Generator to produce either a daytime or nighttime driving depiction of the travel route based upon user input. Similarly, the user may manually select the weather conditions such he or she may selectively cause the Video Generator to produce either a sunny, rainy, snowy, or cloudy depiction of the travel route based upon user input. The user may also manually select the seasonal conditions such he or she may selectively cause the Video Generator to produce one of a winter, summer, fall, or spring depiction of the travel route based upon user input.

The user can selectively pause the playing of a first-person high-video by interacting with User Interface 14 in many embodiments. In this way a user can freeze the image displayed upon the screen if he or she desires further inspection of the image. In addition, User Interface 14 may include standard video playing controls to enable a user to play, fast forward, and rewind a displayed first-person high-speed video. The User Interface 14 may also include a button or control to enable a user to jump to the end of the video, which will generally depict a first person view of the destination location (either the final destination or an intermediate destination if the video only depicts a portion of the travel route). The User Interface 14 may also include a button or control to enable a user to jump to the front of the video, which will generally depict a first person view of the start location. The User Interface 14 may also include a linear slider or other control that allows a user to selectively drive the video forward or backward to a designated spot, allowing easy and rapid fast-forward or rewind to a designated point in the video.

Embodiments of the present invention may also provide the user with a traditional overhead rendering of the travel route upon Display Monitor 18 in addition to displaying the first-person high-speed video of the planned travel route to the user upon Display Monitor 18. The traditional overhead rendering of the travel route may be displayed, for example, as an overhead map view of the geographic region in a format similar to that shown in FIG. 2. In some embodiments a user may selectively switch between the overhead map view of the travel route and the first-person view of the travel route. In some embodiments both views are displayed simultaneously. This may be a highly beneficial mode of display, because when both an overhead map and a first person video are displayed simultaneously a user is given a convenient and highly informative information set with which to review a planned travel route.

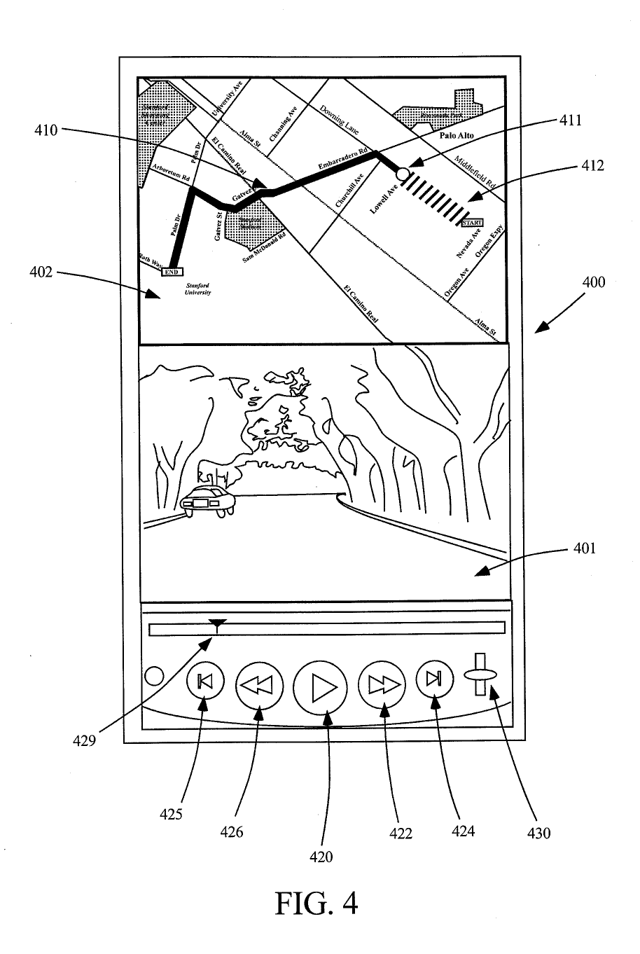

FIG. 4 illustrates a display window that represents how a travel route may be displayed to a user upon a Display Monitor 18 according to at least one embodiment of the invention. As shown, a first person high-speed video rendition is displayed in visual simultaneity with a traditional overhead map rendering of the geographic region. As illustrated, a display area 400 is generated by routines of embodiments of the present invention. Within the display area, a number of sub-areas are displayed and filled with mapping information including a first display area that includes an overhead map rendering 402 of a planned travel route and a first-person video rendition 401 of the same planned travel route.

The overhead map rendering is generally accessed and drawn by Map Selection module 42 based upon data received from Map Database 26. The map database 26 has stored therein overhead map images for both high and low level geographic regions. For example, one map image covers an entire country such as the United States, while other overhead map images cover individual regions (e.g., states or cities or towns) within the country. The user can generally select the zoom-level at which overhead map 402 is displayed. In some embodiments the zoom-level is automatically selected based upon the location and size of a particular planned travel route (i.e., based upon the particulars of the entered start location and destination location). The overhead map images that are accessed from Map Database 26 may be stored in accordance with a data structure such as the one disclosed in U.S. Pat. No. 6,498,982 which has been incorporated herein by reference in its entirely. The overhead map images are often stored as bitmaps and are generally created using a conventional digital cartographic process. In the digital cartographic process, a vector map is first created from Geographic Information System (“GIS”) data, known as “TIGER line data,” available on nine-track tapes from the Census Bureau of the United States government. The TIGER line data includes information about most road segments (often referred to as “links”) within the entire United States, including link name, alternate names for a given link, the type of link (e.g., interstate, highway, limited access, state route, etc.), and the shape of the link. The shape information for a given link includes the latitude and longitude (hereafter “lat/long”) of the end points (often referred to as “nodes”) and intermediate shape points of the link. The TIGER line data is organized in flat files interrelated by record numbers. A more detailed explanation of how such traditional overhead map images are stored and accessed through an automated travel planning application is disclosed in U.S. Pat. No. 6,498,982 which has been incorporated herein by reference in its entirely.

In some embodiments of the present invention, traditional overhead map 402 is annotated with textual and/or graphical elements that depict the planned travel route. For example, a graphical line 410 may be drawn depicting a planned travel route. In this case the planned travel route is from a start location on California Avenue in Palo Alto, Calif. to a destination location upon Stanford University campus in Palo Alto, Calif. The graphical line 410 depicts the planned travel route between these two points. As described previously the planned travel route may be generated by a Routing module 46 with access to a Routing Database 30. A more detailed explanation of how such travel route may be automatically planned by an automated travel planning application is disclosed in U.S. Pat. No. 6,498,982 which has been incorporated herein by reference in its entirely.

In addition to the traditional overhead rendering of the planned travel route, the embodiment of present invention as disclosed with respect to FIG. 4 also displays a visual representation of a first-person high-speed video of the currently planned travel route within a sub-area upon Display Monitor 18. A frozen image of such a first-person high-speed video is shown within display area 401 and depicts a driver's-eye view of the planned travel route as would be seen from a particular location upon a particular road of the designated travel route, as if the user was traveling in the designated direction of the planned travel route. The video may also depict one or more specified ambient conditions such as lighting conditions, weather conditions, and/or seasonal conditions. In this particular example the ambient conditions were selected such that the first-person high-speed video 401 depicts a DAYTIME view and a FALL VIEW of the current travel route.

Thus, a traditional overhead map 402 of the travel area may be displayed along with a graphical depiction 410 of a planned travel route to provide the user with an overhead representation of the planed travel path from the designated start location to the designated destination location. This visual representation of the travel route is referred to herein as a “third person view” of the travel route because the user is looking down upon the planned travel route from afar. As further shown in FIG. 4, this third-person overhead mapping view of the travel area and travel route (402, 410) is displayed by some embodiments of the present invention simultaneously with a first-person video 401 that depicts what it looks like to be actually traveling the planned travel route from the designated start location to the designated destination location. By simultaneously providing both a third-person overhead mapping view of the travel route and a first-person video image view of the route, the routines of embodiments of the present invention help the user to build a clear mental model of the travel route, both as an abstract set of roads and intersections as seen from above and a real-world set of views, landmarks, and turns as seen from the driver-eye perspective. Because both the third-person and first-person views are displayed simultaneously, the user may easily glance back and forth between them at will as he or she builds a mental understanding of the planned travel route and the actions that will be required to traverse it. In FIG. 4 the third person view 402 is presented above the first-person view 401, although in other embodiments they may be presented with a reverse configuration or side-by-side. The key is to present both within the user's visual field so that the user can watch the first person video 401 and glance at will to the overhead mapping view 402 to establish mental correlations between the images seen in the first-person video and the actual roads, distances, and intersections they represent.

To further support a user's ability to build a coherent mental understanding of a planned travel route by looking both a third-person map rendering 402 and a first-person image rendering 401, the routines of embodiments of the present invention may be configured to provide additional inventive graphical features that facilitate the correlation between the images depicted in the first person video 401 and the third-person map rendering 402. In one embodiment of the present invention, a graphical identifier and/or graphical highlight 411 is displayed upon the overhead map view 402 at a location that indicates where within the planned travel route 410, to which the currently displayed first-person video image 401 corresponds. Thus, as the first-person high-speed video 401 is played to the user, the graphical identifiers and/or highlight 411 is rendered upon the overhead map view 402 at a repeatedly changing location that indicates to the user the particular location upon the overhead map that corresponds with the then currently displayed first person image 401. Thus, at any moment in time during the playing of the first-person video 401, the user may glance at the overhead map view 402 and see where upon the overhead map the currently displayed first-person video image relationally corresponds. For example, at the moment in time depicted in the first-person view 401 of FIG. 4, the displayed image is a first-person view of traveling upon Downing Lane. The particular image shown is an intermediate location upon a planned travel route from California Avenue to Stanford University as described previously. This travel route is represented graphically as line 410 upon overhead map 402. To clearly convey the relationship between the particular first-person image that is currently being displayed within the video 401 and the particular geographic location within travel route 410 that the image corresponds, the present invention is configured to draw a graphical indicator and/or highlight 411 upon the overhead map 402 that is repeatedly updated such that it substantially indicates where within travel route 410 the currently displayed first person video image 401 corresponds. At the particular moment in time represented by FIG. 4, the video image 401 corresponds with location 411 upon the overhead map. Thus, a graphical highlight (i.e., the graphical circle shown at 411) is drawn by the routines of embodiments of the present invention as shown in FIG. 4. As the video proceeds forward (i.e., depicts a view of driving forward along the planned travel route), the graphical circle 411 is moved forward along the travel route 410 of the overhead map 402 such that it continues to substantially correspond with the physical location that is then currently depicted by the first person video 401. In this way a user can easily establish the mental relationship between each displayed image depicted in the first-person video rendition 401 and the particular location within the overhead travel route 410 to which the image corresponds.

To further support a user's ability to build a coherent mental understanding of a planned travel route by looking both a third-person map rendering 402 and a first-person image rendering 401, the routines of the present invention may be configured to display a lasting visual trail that indicates which portion of the first-person high-speed video has already been played to the user. Thus at the moment shown in FIG. 4, a portion of the video has already been shown representing the first person travel imagery from the start location to the location indicated by circle 411. This portion of the travel route is thus displayed as graphically highlighted using cross-hatch shading as shown at 412. As the first-person high speed video continues to play, the cross-hatch shading area 412 continues to extend along the planned travel route until eventually the whole travel route is shaded. The whole travel route will finally be shaded as the first-person video depicts the destination location being reached. In this way the routines of the present invention further helps the user to follow the relationship between each currently playing moment depicted in the first-person imagery and the location that the first-person image corresponds to in the graphical route within the overhead geographic map. The portion of the travel route that has been covered in a cross-hatch (or other graphical indicator) also helps the usual visually identify what portion of the travel route has already been displayed by a currently playing first person video.

These simultaneous first-person-image/overhead-map-image display techniques also help the user understand the direction of travel that is being depicted by the video because the motion of the graphical element 411 and/or the extension of the graphical highlight 412 serve as a visual indicator as to the direction of travel depicted in the corresponding first-person imagery. In some embodiments a graphical element is drawn at 411 that it indicates a direction of travel, such as an arrow or other directional graphical element, to indicate the direction of travel represented by the video 401.

As discussed above, the user of an embodiment of the present invention may interact with User Interface 14 to selectively play, pause, rewind, fast-forward, frame advance, and/or jump to particular locations with the first-person high-speed video. An example user interface that follows a traditional video display interface configuration is shown in FIG. 4. As shown, a user may interact with a button 420 to cause the first person video to play. As the video plays, a frame-counter bar 429 advances across the screen, indicating visually what portion of the video has thus far been displayed. The user may grab frame-counter bar 429 and selectively advance and/or rewind the video at will. This enables the user to quickly move forward and/or backward within the first person travel route. The user may also fast forward by pressing button 422. The user may also rewind by pressing button 426. The user may jump to the start location depiction in the video by pressing 425. The user may jump to the destination location depiction in the video by pressing button 424. Also, as described above, as the video is advanced or rewound based upon interaction with controls (425, 426, 420, 422, 424, or 429), the graphical indicator 411 and/or the route highlight 412 will be adjusted such that the currently displayed video image corresponds with the location represented by indicators 411 and/or 412. In some embodiments the user may grab graphical indicator 411 (with a cursor or other user interface element) and manually manipulate it upon map image 402. Embodiments of the present invention adjust the video image display 401 such that the currently displayed first-person view corresponds with the manipulated location of indicator 411 upon graphical route 410. In this way a user may move the graphical indicator 411 to a particular location within route 410 on map 402 and may immediately see a corresponding first person view 401 that represents the current location of graphical indicator 411. This is a highly convenient way for a user select locations within a route upon a graphical map and see the corresponding first person location. For example, if the user wants to see what a particular intersection within travel route 410 looks like from a first person perspective, he or she may click upon a particular location within the travel route 410 and/or may adjust the location of graphical indicator 411 and move it to a particular location upon travel route 410. In response to the user interaction, a first person image corresponding to the selected location is displayed in area 401. The first person image may be a still image in the first person perspective. The user may then press play 420 and cause the first person video to play forward from the selected image forward to the end of the video.

The User Interface 14 of the present invention may also include a slider 430 or other manipulable control that is mapped to a playback frame-rate value for the video display routines. In the example shown in FIG. 4, when the slider is centered along its path of travel a nominal frame rate is used for the display of the video. When the slider is pushed above the center location by a user interaction, a faster than nominal playback frame rate is used, the further the slider is pulled down the faster the frame rate. When the slider is pulled below the center location by a user interaction, a slower than nominal playback frame rate is used, the further the slider is pulled below the center the slower the frame rate. In this way the user may manually adjust the playback speed of the first-person high speed video, selectively scaling the speed of the displayed travel route video depending upon his or her desires. Thus, the Video Generator may generate a first-person high speed video using the methods described above and may produce a video with a nominal frame rate of 25 frames per second. The user may play the video at a rate faster or slower than the nominal rate using the optional provided control 430.

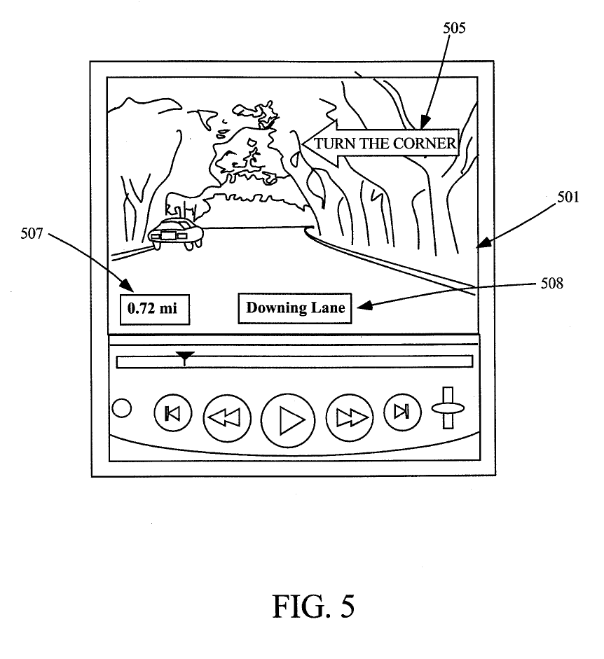

In some embodiments of the present invention the real-world first-person video imagery may be annotated with textual and/or graphical overlays that inform the user about travel instructions and/or travel information related to the currently displayed first-person view. For example, street names, distances to intersections, accrued mileage, and/or upcoming turns and/or stops may be provided by the display routines of embodiments of the present invention as graphical overlays presented upon the real-world first-person video imagery of a planned travel route from a designated start location to a designated destination location. FIG. 5 illustrates an example User Interface 14 according to at least one embodiment of the invention. As shown, a first-person video image 501 is illustrated that is annotated with an overlaid travel instruction 505, an overlaid accrued mileage value 507, and an overlaid street name indicator 508. Each of the elements (505, 507, and 508) is rendered as a graphical overlay upon the first person video imagery such that the appropriate travel instruction, mileage indicator, and/or street name appears as the corresponding frames of the video are displayed. Thus, when certain video frames are displayed that show first-person views of traveling down a particular roadway in the planned travel route, an overlay that indicates that particular roadway name 508 is presented upon those certain video frames. This enables the user to easily correlate a displayed first person video image of traveling down a particular roadway with the name of that roadway.

With respect to the overlaid travel instruction 505 that indicate an upcoming travel event such as a turn or stop, a particular graphical overlay is displayed upon certain frames of the first-person video imagery, those certain frames depicting the approach to the location where that particular travel instruction is required. For example, the video image 501 shown in FIG. 5 depicts the first person view of the travel route as it heads along Downing Lane in Palo Alto. As the video imagery approaches the intersection where Downing Lane crosses Embarcadero Road, a travel instruction 505 is overlaid upon the video imagery informing the user that a left turn is required at the next intersection. In this way the user is prepared for the upcoming video depiction of the turn from Downing Lane onto Embarcadero Road and may thus prepare himself or herself to carefully watch the first-person video depiction of the turn. This will help the user recognize visual landmarks that precede the turn or other depicted travel event. In the example shown travel instruction 505 is drawn as an arrow indicating that an upcoming turn is required, the arrow pointing in the direction of the required turn. In other embodiments other graphical and/or textual instructions may be used to depict the upcoming driving instructions that correspond with a given travel route. In general the driving instructions are derived from the routing data that has been generated as described previously in this document by routing module 46 of the present invention. Because the routing data was used to generate the video itself, the same data may easily be used to insert the overlaid travel instruction images upon the correct video frames of the first-person video. For example, the system may be configured to use the routing data and insert the travel instruction 505 as an overlay upon those video images that are relationally associated with that portion of the travel route that precede the upcoming turn by less than a half mile. Thus, all of the frames that are relationally associated with Downing Street in the first-person image database and are less than a half mile away from the intersection at Embarcadero will be annotated with the overlaid travel instruction 505. In some embodiments a larger distance than a half mile may be used. For example, on roads of travel that have a higher speed limit such as a freeway, a larger preceding distance may be used for travel instruction annotations, such as two miles. In this way a first person video of traveling upon a freeway may be annotated with travel instructions for taking a required exit upon the travel route by inserting annotated travel instructions on all those frame that precede the exit by less than two miles. Because each image used in the video is stored in the first-person image database with a relational association to a roadway and location upon that roadway, the determination as to how close that image is to an upcoming travel event (i.e. a turn, exit, or stop) required by the routing data is easy to determine by a numerical comparison.

In addition to travel instructions and street identifiers, other graphical and/or textual information may be overlaid upon the first-person video rendition of the travel route. For example, accrued travel mileage information may be presented as a graphical overlay shown as element 507 in FIG. 5. The mileage information is repeatedly updated such that it substantially indicates the current mileage covered in the travel route as depicted by the first-person high-speed video 501. Such a mileage display helps a user correlate his or her viewing of a displayed first-person high-speed video with the actual mileage it represents. In addition, a textual indication of the current road of travel as depicted in the currently playing video footage may be displayed as shown by example at element 508 in FIG. 5. The overlaid street name is repeatedly updated as the video footage depicts travel upon different roads of travel as indicated by the routing data. Such a street name display helps a user correlate the viewing of a displayed first-person high-speed video with the actual road of travel that is then currently depicted.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method for providing a first-person view of a travel route, comprising:
receiving a start location and a destination location for the travel route from a user;
planning the travel route based between the start location and the destination location;
generating high-speed video media depicting at least a portion of the travel route from the start location to the destination location along a planned travel path, wherein the video media is generated by sequencing a series of previously stored still images associated with locations between the start location and the destination location, the still images displaying first photographic imagery in a driving direction of the travel route; and
displaying the high-speed video media to the user.

2. The method of claim 1, wherein each of the previously stored images is associated with identification data, the identification data comprising at least one of Global Positioning System data, street identification data, and travel direction data.

3. The method of claim 1, wherein the high-speed video media is played at a fast frame-rate to allow the user to view a full travel route over a short duration of time.

4. The method of claim 1, wherein the previously stored images corresponding to locations along the travel route depict locations approximately evenly spaced from each other for portions of the travel route.

5. The method of claim 4, wherein the previously stored images corresponding to the portions of the travel route corresponding to roads having high speed limits depict locations spaced further apart than the portions of the travel route corresponding to roads having lower speed limits.

6. The method of claim 1, wherein the previously stored images utilized to generate the high-speed video media are selected based in part on at least one of a current season, current weather condition, current lighting conditions, and an anticipated time of day on which the user plans on traveling along the travel route.

7. The method of claim 6, wherein information corresponding to the at least one of current season, current weather condition, current lighting conditions, and the anticipated time of day on which the user plans on traveling along the travel route is provided by the user.

8. The method of claim 6, wherein information corresponding to at least one of the current season, current weather conditions, current lighting conditions, and the anticipated time of day, is determined based at least in part upon at least one of a date and a time of anticipated travel departure entered by the user.

9. The method of claim 1, further comprising simultaneously displaying the high speed video media and a third person overhead map imagery corresponding to the travel route.

10. The method of claim 1, further comprising displaying corresponding overlaid travel instructions, accrued mileage, and current street names during the displaying of the video media.

11. A system for providing a first-person view of a travel route, comprising:
a user interface to receive a start location and a destination location for the travel route from a user;
a routing component to plan the travel route based between the start location and the destination location;
a first person image database to store still images associated with locations between the start location and the destination location, the still images displaying first person photographic imagery in a driving direction of the travel route;
a video generator to generate high-speed video media depicting at least a portion of the travel route from the start location to the destination location along a planned travel path, wherein the video media is generated by sequencing a series of the still images associated with locations between the start location and the destination location; and
a video display to display the high-speed video media to the user.

12. The system of claim 11, further comprising a routing database to store routing information used by the routing component, the routing information relating to the roads of travel included in the travel route.

13. The system of claim 12, wherein the routing database includes node and link data for a plurality of roads within the travel route.

14. The system of claim 11, further comprising a map database for storing geographic map data and overhead map images for geographic regions.

15. The system of claim 11, wherein each of the still images are associated in the first person image database with identification data, the identification data comprising at least one of Global Positioning System data, street identification data, and travel direction data.

16. The system of claim 11, wherein a plurality of the still images are associated in the first person image database with identification data, the identification data including all three of global positioning data, street identification data, and travel direction data.

17. The system of claim 11, wherein the video generator is adapted to high-speed video media is played at a fast frame-rate to allow the user to view a full travel route over a short duration of time.

18. The system of claim 11, wherein the still images correspond to locations along the travel route depicting locations approximately evenly spaced from each other for portions of the travel route.

19. The system of claim 18, wherein the still images corresponding to the portions of the travel route corresponding to roads having high speed limits depict locations spaced further apart than the portions of the travel route corresponding to roads having lower speed limits.

20. The system of claim 11, wherein the user interface is adapted to receive, from the user, information corresponding to the current weather season and the anticipated time of day on which the user plans on traveling along the travel route.

21. The system of claim 15, wherein the identification data associated with at least one still image includes data indicating at least one of a season, weather conditions, lighting conditions, and a time of day of the at least one still image.

22. The system of claim 11, further comprising simultaneously displaying to the user the high-speed video media and third person overhead map imagery correspond to the travel route.

23. A method for a video generation module to generate a first-person view of a travel route, the method comprising:
receiving a planned travel route based between a start location and a destination location;
accessing a first person image database that stores still images associated with locations between the start location and the destination location, the still images displaying imagery in a driving direction of the travel route;
generating high-speed video media depicting at least a portion of the travel route from the start location to the destination location along a planned travel path, wherein the video media is generated by sequencing a series of previously stored still images associated with locations between the start location and the destination location, the still images displaying first person photographic imagery in a driving direction of the travel route; and
providing the high-speed video media to a display device.

24. The method of claim 23, wherein the still images utilized to generate the high-speed video media are selected based in part on at least one of a current weather season, a current weather condition, a current lighting condition, and an anticipated time of day on which the user plans on traveling along the travel route.

25. The method of claim 23, wherein still images within the first person image database are indexed with respect to both the physical location depicted in the image content and the direction of road travel depicted in the image content.

26. The method of claim 23, wherein the high-speed video media depicts a faster rate of travel during portions of the travel route that do not require the driver to prepare to make a turn from one road to another and a slower rate of travel during portions of the travel route that do require the driver to prepare to make a turn from one road to another.

27. The method of claim 23, wherein the high-speed video media depicts a faster rate of travel during portions of the travel route that correspond to highway travel and a slower rate of travel during portions of the travel route that correspond to surface street travel.

28. The method of claim 23, wherein the high-speed video media depicts a daylight view of the travel route during anticipated travel times that correspond with daylight hours and depicts a nighttime view of the travel route during anticipated travel times that correspond with nighttime hours.
